(19) United States
(12) Patent Application Publication
(10) Pub. No.: US 2003/0044132 A1
(43) Pub. Date: Mar. 6, 2003

(54) Laser module

(75) Inventors: Hideyuki Nasu, Tokyo (JP); Takehiko Nomura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/229,032

(22) Filed: Aug. 28, 2002

(30) Foreign Application Priority Data
Aug. 29, 2001 (JP) 2001-259979

(51) Int. Cl. G02B 6/42; H01S 3/00

(52) U.S. Cl. 385/92; 372/33

(57) ABSTRACT

First and second temperature control modules are disposed on a bottom surface inside a package. The first module has a prism, a wavelength filter, and a mount that holds a photodiode disposed thereon, thereby to form a wavelength monitoring section. The second module has an isolator, a lens holder that holds a lens, a laser mount on which a laser device is fixed, and a lens holder that holds a lens disposed thereon, thereby to form a laser emitter. An insulating plate is disposed between the first and second modules so as to prevent the occurrence of interference between the first and second modules.

### BACKGROUND OF THE INVENTION

1) Field of the Invention

The present invention relates to a laser module that is used as a light source for optical data communications and the like.

2) Description of the Related Art

Conventionally, there has been known a laser module that uses a semiconductor laser device as a light source for optical data communications and the like. Particularly, in optical data communications, along the development of a wavelength division multiplexing (hereinafter to be referred to as WDM) system in recent years, it has been required to control oscillation wavelengths of laser beams in the order of a few pm. Therefore, a wavelength monitoring section is provided in addition to a laser device and a necessary optical system, inside the laser module. A controller stabilizes the oscillation wavelength of the laser device to a predetermined value based on information obtained by the wavelength monitoring section.

FIG. 10 is a schematic view which shows a structure of the laser module that has the wavelength monitoring section. This laser module has a laser device 69, an optical system 77, and a wavelength monitoring section 66 within a package 70, and has a lid portion 67 to seal the inside of the package 70. The laser device 69 that is held on a laser mount 68 emits a laser beam to the forward direction (rightward in FIG. 10). The laser beam is converged by the optical system 77 including lenses and by a ball lens 73 to be guided to an optical fiber 76, and utilized as signal light.

On the other hand, a laser beam that has been emitted to a backward direction (leftward in FIG. 10) is guided to the wavelength monitoring section 66. The wavelength monitoring section 66 uses this laser beam to monitor the wavelength. Specifically, the laser beam that has been emitted to the backward passes through a filter that is provided inside the wavelength monitoring section 66, and is incident to a photodiode. The photodiode converts the incident light into a current. Therefore, it is possible to electrically measure the intensity of a component of a specific wavelength that has passed through the filter, out of the laser beam. When the wavelength of the laser beam has changed from a specific wavelength, the quantity of the light that is incident to the photodiode changes based on the work of the filter. Therefore, it is possible to detect a change in the wavelength of the laser beam, by monitoring the current that is output from the photodiode. When the photodiode detects a change in the wavelength of the laser beam, a controller not shown changes the quantity of the current that is flown to a temperature control module 64, thereby to control the temperature of the laser device 69. Consequently, the oscillation wavelength of the laser device 69 is returned to a predetermined value.

In the filer provided in the wavelength monitoring section 66, a wavelength discrimination characteristic generally has a temperature dependency. When the temperature of the filter has changed, the characteristic (the wavelength discrimination characteristic) of wavelength and wavelength monitor PD current drifts. Therefore, a point of locking the wavelength also drifts from a predetermined wavelength. In order to stabilize the wavelength discrimination characteristic, the temperature of the filter is controlled to be constant. The wavelength monitoring section 66 is disposed on a temperature control module 65. The temperature control module 65 controls the temperature of the wavelength monitoring section 66 to be maintained constant.

On the other hand, it is the object of the control to keep constant the oscillation wavelength of the laser device 69. Therefore, it is not always necessary to keep constant the temperature of the laser device 69. For example, when a current injected to the laser device 69 has increased, the oscillation wavelength shifts to a long wavelength side, even when the temperature is constant. Consequently, it is necessary to lower the temperature of the laser device 69 by controlling the temperature control module 64.

As the temperature control of the wave monitoring section 66 is different from the temperature control of the laser device 69 as explained above, the laser module is in the structure having a plurality of temperature control modules. The respective temperature control modules 64 and 65 independently control temperatures.

Disposition of the two temperature control modules 64 and 65 inside the package 70 raises a new problem. The laser module usually uses a butterfly package of 14 pins as the package 70. This package 70 has sizes of about only 18 mm×8 mm for the bottom surface inside the package. On the other hand, one temperature control module has sizes of about 6 mm×5 mm as smallest sizes. Therefore, the inside of the package 70 does not have sufficient sizes to accommodate the two temperature control modules 64 and 65. There is, in many cases, a design gap of only about 1 mm between the temperature control module 64 and the temperature control module 65. The temperature control modules 64 and 65 are usually fixed by soldering. A positional displacement of about 1 mm occurs when these temperature control modules are fixed. Therefore, the two temperature control modules may be in contact with each other. Consequently, the following problems occur.

Heat exchanges between the two temperature control modules 64 and 65 occur. While the temperature control module 65 that holds the wave monitoring section 66 is kept at a constant temperature as described above, the temperature control module 64 that holds the laser device 69 may change the temperature in order to keep constant the wavelength of the laser beam. At this time, there occurs a difference between the temperatures of the temperature control modules 64 and 65. When the two temperature control modules are located close to each other or are in contact with each other in this environment, a shifting of heat between the temperature control modules 64 and 65 easily occurs. In order to maintain a predetermined temperature, it is necessary to suppress the temperature change due to the flow of heat, and it is necessary to supply an additional current to the temperature control modules 64 and 65. This brings about a problem of the increase in power consumption of the laser module. When there is a very large difference between the temperatures of the temperature control modules 64 and 65, a large quantity of heat shifts, which becomes impossible to control this temperature. Consequently, it becomes impossible to use the laser module.

There is also a problem of a current conduction between the two temperature control modules 64 and 65. As each temperature control module controls temperature with a current, the temperature control module incorporates an electric circuit. Therefore, when the module 64 and the module 65 are in contact with each other, the electric circuits that are incorporated in both of the modules are also brought into contact with each other. This brings about a shortage of electricity. Even when the modules are not in contact with each other, a current may be conducted via other members, or may be conducted via solder that has been used to form the electric circuits. When this occurs, it becomes impossible to correctly flow a current to the electric circuits that are incorporated in the temperature control modules, and thereby the module 64 and the module 65 cannot perform a predetermined temperature control respectively. Consequently, it becomes impossible to use the laser module.

In order to solve these problems, it may be considered possible to increase the bottom area inside the package 70. However, it has been strongly desired to provide a small laser module, and therefore, there is a limit to increasing the bottom area. When a package having different sizes from those of the normal package is used, it becomes necessary to change the total design of the communication system.

It may be considered possible to reduce the sizes of the temperature control module 64 and the temperature control module 65 respectively. However, the reduction in the sizes of the temperature control modules results in a reduction in the temperature control function. Therefore, it is not practical to reduce the sizes of the temperature control modules.

Although the structure having two temperature control modules disposed in the laser module is shown as an example of the conventional technique in FIG. 10, other structures having three or more temperature control modules disposed may also be considered. For example, the optical system 77 and the laser device 69 shown in FIG. 10 are disposed on separate temperature control modules respectively. However, this structure has a larger possibility that the temperature control modules are in contact with each other. Therefore, it becomes necessary to prevent the temperature control modules from being in contact with each other.

### SUMMARY OF THE INVENTION

It is an object of the present invention to provide a laser module capable of preventing temperature control modules disposed inside a package from mutually exerting influences upon their characteristics.

The laser module comprising according to the present invention includes a first temperature control module that is disposed inside a package, and a second temperature control module, a laser device that is disposed on the first temperature control module. This module also includes a wavelength monitoring section that is disposed on the second temperature control module and detects a wavelength of a light emitted from the laser device, and a module separating unit that has a device separating member that is disposed between the first and second temperature control modules and that separates the temperature control modules from each other.

According to the invention, when the first temperature control module and the second temperature control module are disposed inside the package, the module separating unit is disposed between these temperature control modules. The module separating unit prevents the temperature control modules from being in contact with each other.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a cross-sectional view which shows a structure of a laser module according to a first embodiment of the present invention,

FIG. 2 is a top plan view which shows the structure of the laser module according to the first embodiment,

FIG. 3 is a cross-sectional view which shows a structure of a temperature control module according to the first embodiment,

FIG. 4 is a cross-sectional view which shows a structure of a laser module according to a second embodiment of the present invention,

FIG. 5 is a top plan view which shows the structure of the laser module according to the second embodiment,

FIG. 6 is a cross-sectional view which shows a structure of a laser module according to a third embodiment of the present invention,

FIG. 7 is a cross-sectional view which shows a structure of a laser module according to a fourth embodiment of the present invention,

FIG. 8A and FIG. 8B are views which show a structure of a module separating plate in the fourth embodiment,

FIG. 9 is a cross-sectional view which shows a structure of a temperature control module according to a fifth embodiment of the present invention, and

FIG. 10 is a schematic view which shows the structure of the laser module according to the conventional technique.

### DETAILED DESCRIPTION

Embodiments of the laser module according to the present invention will be explained in detail below with reference to the drawings. In the drawings, identical or similar sections are attached with identical or similar reference symbols. It should be noted that the drawings are schematic views, and the sizes and ratios of constituent elements of apparatuses are different from real ones. It is needless to mention that the drawings also include sections of which sizes and ratios are different between the drawings.

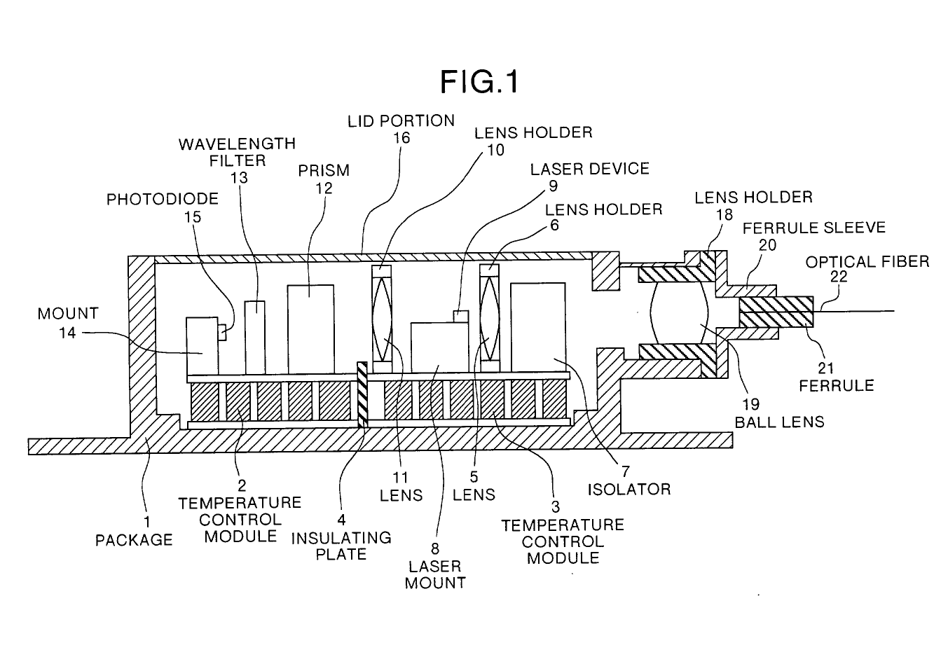

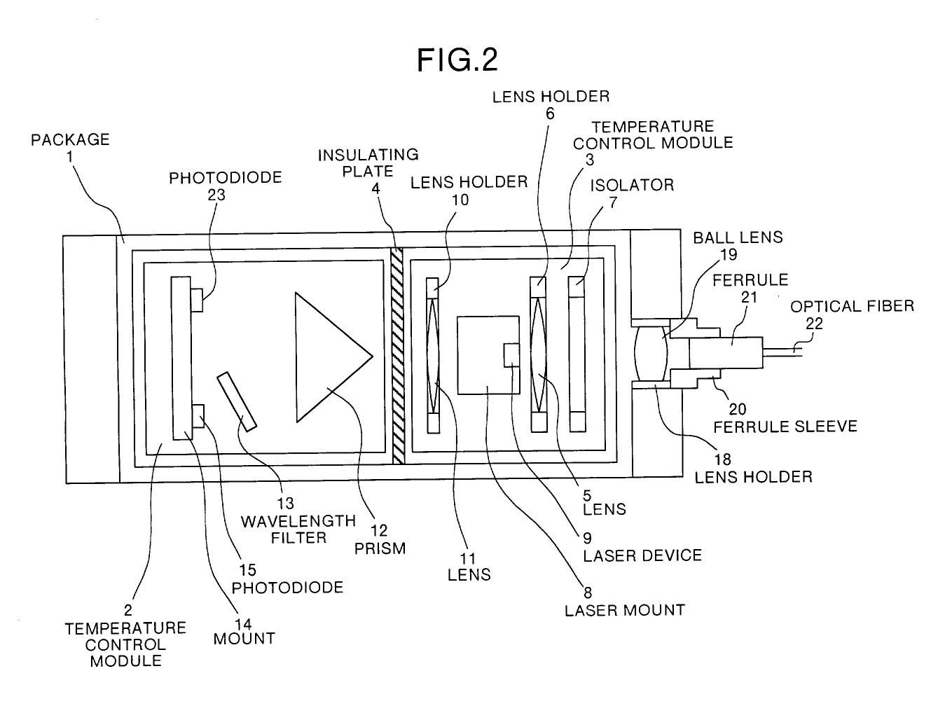

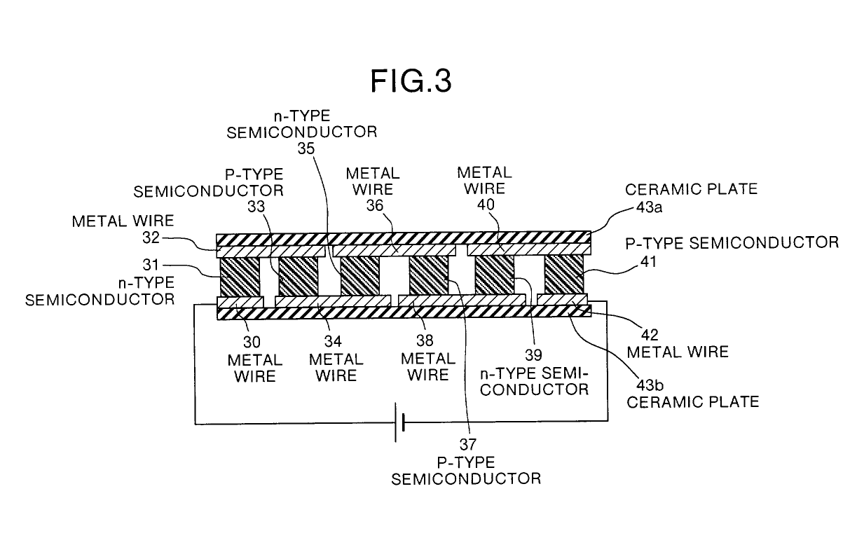

A laser module according to a first embodiment of the present invention will be explained with reference to FIG. 1 to FIG. 3. FIG. 1 is a cross-sectional view which shows the structure of a laser module according to the first embodiment. FIG. 2 is a top plan view which shows the structure of the laser module according to the first embodiment. FIG. 3 is a cross-sectional view which shows the structure of a temperature control module according to the first embodiment. As shown in FIG. 1, the laser module according to the first embodiment has a temperature control module 2 and a temperature control module 3 disposed on the bottom surface inside a package 1. The temperature control module 2 has a prism 12, a wavelength filter 13, a mount 14, and photodiodes 15 and 23 that are fixed on the mount 14, disposed thereon. The temperature control module 3 has an isolator 7, a laser mount 8, and lens holders 6 and 10, disposed thereon. A laser device 9 is disposed on the laser mount 8. Lenses 5 and 11 are held on the lens holders 6 and 10 respectively. An insulating plate 4 is disposed between the module 2 and the module 3 to electrically isolate the module 2 from the module 3.

The package 1 has an opening section at an upper portion and at a front portion (rightward in FIG. 1) of the package, respectively. The package 1 can also have the temperature control modules 2 and 3 disposed on the bottom surface inside the package. The front opening section is provided to link a laser beam to an optical fiber 22. A ball lens 19 is fixed to this opening section via a lens holder 18. The optical fiber 22 is further connected to this front opening section via a ferrule sleeve 20 and a ferrule 21. The upper opening section of the package 1 is covered with a lid portion 16, thereby to form a sealed space inside the package 1 that is isolated from the outside of the package.

On the laser mount 8, the laser device 9 is fixed. The laser mount 8 transmits heat generated by the laser device 9 to the temperature control module 3. Therefore, the laser mount 8 is made of, for example, aluminum nitrogen (AlN) crystal that is excellent in heat conductivity.

The laser device 9 has a diffraction grating in the vicinity of an active layer, and is made of a semiconductor laser device like distributed feedback (DFB) laser that transmits a single longitudinal mode. In the first embodiment, a double hetero-structure laser (DH laser) that has an active layer made of InP is used for the laser device 9. It is also possible to use a single hetero-structure laser or a laser made of other semiconductor. In the first embodiment, the laser device 9 emits laser beams to the forward direction and the backward direction from two reflection surfaces that form a resonator. The laser beam emitted to the forward direction is guided to the optical fiber 22, and the laser beam emitted to the backward direction is used to monitor a wavelength.

The lens 5 is used to link the laser beam emitted to the forward direction from the laser device 9 to an optical fiber not shown. The lens 5 is held by the lens holder 6 and is disposed on the temperature control module 3 at the front of the laser mount 8.

The isolator 7 interrupts a beam, out of the laser beam that has been emitted to the optical fiber 22, that is reflected from the optical fiber 22 and is returned to the inside of the laser module.

The lens 11 is used to change the laser beam emitted to the backward direction from the laser device 9 to be parallel beams. The lens 11 is held by the lens holder 10 and is disposed on the temperature control module 3 at the back of the laser mount 8.

The prism 12 separates the laser beam that emitted to the backward direction from the laser device 9 so that the separated laser beams are incident to the photodiode 15 and the photodiode 23, as shown in FIG. 2. It is possible to use glass and other various kinds of resins as a material of the prism 12.

The wavelength filter 13 transmits only a beam of a specific wavelength in one direction of the beams obtained by being split by the prism 12. The wavelength filter 13 is made of a dielectric multilayer film, and has a characteristic of changing the transmission wavelength depending on the incident angles of laser beam components that are incident to the wavelength filter 13. The wavelength filter 13 is held by a holder not shown and is disposed on the temperature control module 2. This holder allows the wavelength filter 13 to rotate around its vertical direction as a rotary axis.

The photodiode 15 measures the intensity of a beam of a specific wavelength that has passed through the wave filter 13, out of the laser beams emitted to the backward direction from the laser device 9 and obtained by being split by the prism 12. Specifically, the photodiode 15 outputs a current according to the intensity of the irradiated light. Therefore, the photodiode 15 is connected to an external circuit not shown, to measure a current, and monitor a change in the intensity of the light of a wavelength that is used as signal light out of the laser beams.

The photodiode 23 is disposed on the mount 14. The photodiode 23 measures the intensity of the laser beam that has not passed through the wave filter 13, out of the laser beams emitted to the backward direction from the laser device 9 and obtained by being split in two directions by the prism 12.

The temperature control modules 2 and 3 are constructed of a Peltier device, respectively. The peltier device has the following structure. As shown in FIG. 3, n-type semiconductors 31, 35 and 39 and p-type semiconductors 33, 37 and 41 are alternately disposed between flat ceramic plates 43a and 43b. These semiconductors are electrically connected to each other via metal wires 30, 32, 34, 36, 38, 40, and 42.

The n-type semiconductors 31, 35 and 39 are prepared by diffusing an n-type impurity like phosphor (P) atom in the silicon (Si) crystal. The p-type semiconductors 33, 37 and 41 are prepared by diffusing a p-type impurity like boron B atom in the silicon crystal.

The metal wires 30 and 42 are electrically connected to an external power source in order to introduce a current into the peltier device. The metal wires 30 and 42 are disposed by being exposed to the side surface of the Peltier device in order to have a connection with the external power source. The metal wires 30, 32, 34, 36, 38, 40 and 42 are made of a metal like gold that has an ohmic contact with the Si crystal.

The ceramic plates 43a and 43b are two plates having the same shape. The ceramic plates 43a and 43b are made of a material having high thermal conductivity in order to rapidly heat or cool the object that is in contact with the temperature control modules 2 and 3. Therefore, the material of these ceramic plates is not necessarily limited to ceramic if the material has excellent thermal conductivity and has sufficient strength to have the object disposed on it. The ceramic plates 43a and 43b need to have as large surface area as possible in order to efficiently achieve heat conduction to and heat absorption from the object that is in contact with these ceramic plates. For this purpose, the ceramic plates 43a and 43b extend to the side surface of the Peltier device.

The insulating plate 4 is used to electrically separate the temperature control module 2 from the temperature control module 3, as shown in FIG. 1. The material of this insulating plate 4 may include a glass-cloth reinforced epoxy resin that is used for a printed circuit board, a polyimide resin, a paper phenol resin, mica, and glass. The material may also include an epoxy resin, polyethylene, and Teflon that have an insulation characteristic.

The operation of the laser module according to the first embodiment will be explained next. The laser module according to the first embodiment is mainly utilized as a signal light source for optical fiber communications. Specifically, the laser module emits the laser beam that has been emitted to the forward direction from the laser device 9 as signal light to the optical fiber 22 through the opening section provided at the front. In order to use the laser beam as the signal light, it is essential that the output intensity and the wavelength are stable.

On the other hand, the output intensity of the laser beam emitted from the laser device 9 basically increases monotonously relative to the current that is injected to the active layer of the laser device 9, and decreases monotonously relative to the temperature of the active layer. The oscillation wavelength increases monotonously relative to the injection current and the temperature of the active layer. Therefore, it is possible to stabilize the output intensity and the wavelength of the laser beam by controlling the current injected to the active layer of the laser device 9 and the temperature of the active layer.

In order to stabilize the wavelength, the laser beam emitted from the back of the laser device 9 is utilized. As shown in FIG. 2, the laser beam emitted from the back of the laser device 9 becomes parallel beams when passing through the lens 11, and the parallel beams are incident to the prism 12. The laser beams incident to the prism 12 are split into two directions. The laser beam that has proceeded to one of the two directions is incident to the wavelength filter 13. Only a laser beam of a predetermined wavelength passes through the wavelength filter 13. The laser beam that has passed through the wavelength filter 13 is incident to the photodiode 15. The photodiode 15 outputs a current corresponding to the intensity of the incident light. Therefore, it is possible to measure the intensity of the wavelength component that is used as signal light, by setting the wavelength filter 13 in advance such that the predetermined wavelength becomes equivalent to the wavelength of the signal light. The other laser beam obtained by being split by the prism 12 is used as reference light, and the intensity of this reference light is measured by the photodiode 23. Based on this, noise due to the fluctuation of the injection current is removed. When the wavelength of the laser beam emitted from the laser device 9 has shifted from a predetermined wavelength, the current that is output from the photodiode 15 becomes low. Therefore, it is possible to return the wavelength of the laser device 9 to the predetermined wavelength, when the temperature control module 3 controlled by a controller not shown adjusts the temperature of the laser device 9.

The temperature control carried out by the temperature control modules 2 and 3 will be explained next. The temperature control modules 2 and 3 are constructed of the Peltier device as explained above. The Peltier device adjusts temperature based on the Peltier effect. Specifically, the Peltier device has the structure as shown in FIG. 3. When a current is flown from the n-type semiconductor 31 to the p-type semiconductor 33, the metal wire 32 between the n-type semiconductor 31 and the p-type semiconductor 33 absorbs heat based on the Peltier effect. The metal wires 36 and 40 also absorb heat based on the same Peltier effect. The ceramic plate 43a disposed on the top of the Peltier device is in contact with the metal wires 32, 36 and 40. Therefore, when a current is flown to a direction shown in FIG. 3, the heat of the object disposed on the ceramic plate 43a is absorbed, and the temperature of the object falls.

On the other hand, as a current is flown from the p-type semiconductor 33 to the n-type semiconductor 35, heat is discharged from the metal wire 34. Similarly, heat is discharged from the metal wire 38 as well. The ceramic plate 43b is disposed beneath the metal wires 34 and 38. Therefore, when a current is flown in the direction shown in FIG. 3, the temperature of the object that is in contact with the lower surface of the ceramic plate 43b rises.

The heat absorption quantity or the heat discharge quantity is proportional to the magnitude of the current that is flown to the Peltier device. When a current is flown in the direction opposite to the direction shown in FIG. 3, heat shifts in the opposite direction, and therefore the ceramic plate 43a discharges heat while the ceramic plate 43b absorbs heat. As explained above, the Peltier device can control the temperature of the object that is in contact with the ceramic plate, based on the magnitude and the direction of the current that is flown to this device. Therefore, in order to achieve a fine control of the temperatures of the laser device 9 and the wavelength filter 13, it is necessary to accurately control the current that flows to the temperature control modules 2 and 3.

Therefore, in the first embodiment, the insulating plate 4 is disposed between the temperature control module 2 and the temperature control module 3 to prevent the occurrence of a current conduction between the module 2 and the module 3. The Peltier device that constitutes each of the modules 2 and 3 has a structure that the metal wires are exposed to the side surface as shown in FIG. 3. When the module 2 is in contact with the module 3, a current is conducted between the metal wires in contact with the temperature control modules, and a current flows between the modules 2 and 3. Consequently, it becomes impossible to control the temperature from the external circuit, which makes it impossible for the temperature control modules to achieve their functions. By disposing the insulating plate 4 between the temperature control modules in order to reliably avoid the occurrence of this situation, it becomes possible to accurately control the temperature of the laser device 9 and the like that are disposed on the modules 2 and 3.

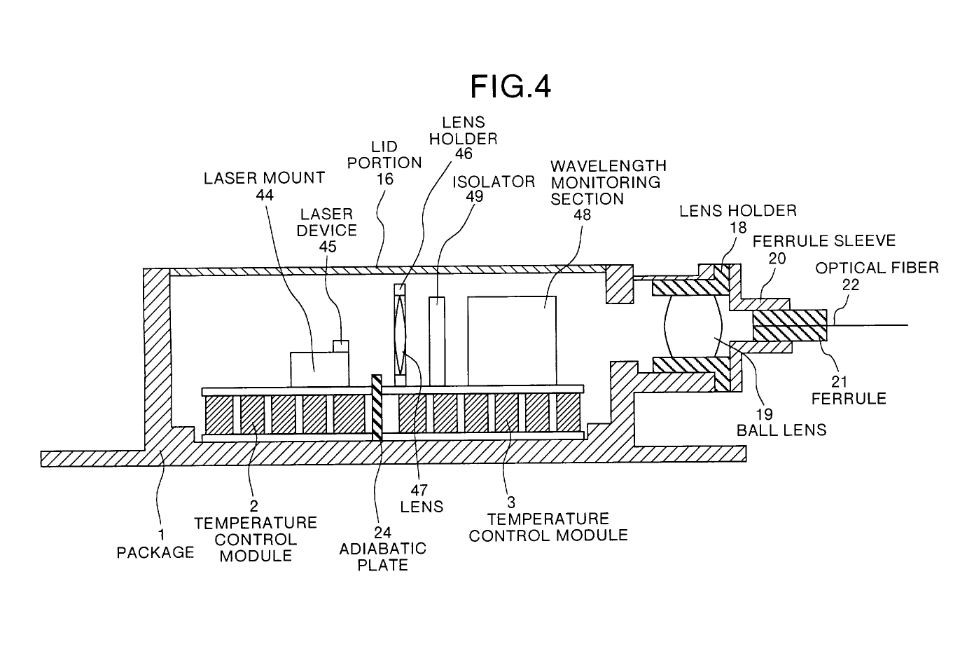

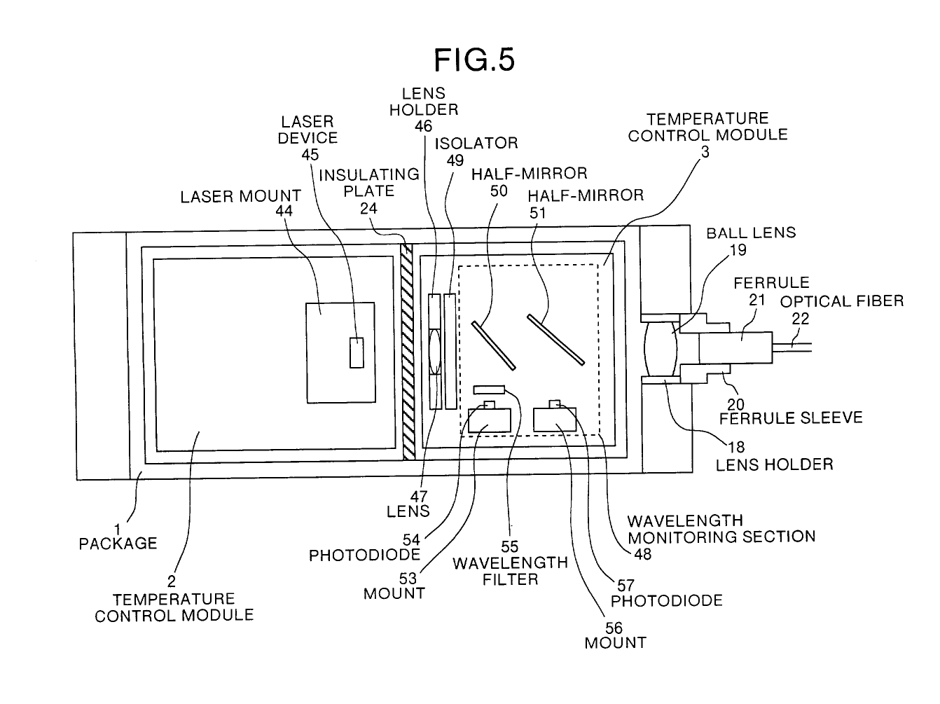

A second embodiment of the present invention will be explained next. FIG. 4 is a cross-sectional view which shows the structure of a laser module according to the second embodiment. FIG. 5 is a top plan view which shows the structure of the laser module according to the second embodiment. Sections that are common to those of the first embodiment are assigned with identical or similar reference symbols.

The laser module according to the second embodiment has the temperature control module 2 and the temperature control module 3 disposed on the bottom surface inside the package 1. An adiabatic plate 24 is disposed between the modules 2 and 3. A laser mount 44 is disposed on the module 2. A laser device 45 is disposed on the laser mount 44. An isolator 49 and a wavelength monitoring section 48 are disposed on the module 3. Further, a lens 47 held by a lens holder 46 is disposed on the module 3. The internal space of the package 1 is filled with inert gas. A lid portion 16 is disposed on an upper opening section of the package to avoid the influence from the outside.

The adiabatic plate 24 is disposed to thermally separate the temperature control module 2 from the temperature control module 3. The adiabatic plate 24 has a flat plate shape. A porous material such as glass fiber, ceramic fiber, rock wool, or foamed cement can be used for the material of this adiabatic plate 24. Foamed urethane and foamed polystyrene can also be used for the material. Other materials having satisfactory heat insulation property can be used for the material of the adiabatic plate 24.

In the laser module according to the second embodiment, the wavelength monitoring section 48 is disposed in front of the laser device 45 (rightward in FIG. 4), unlike the first embodiment, and monitors the wavelength by using a part of the laser beam emitted to the forward direction from the laser device 45. The isolator 49 is disposed on the temperature control module 3, instead of the temperature control module 2 on which the laser device 45 is disposed.

The wavelength monitoring section 48 has half-mirrors 50 and 51 disposed in front of the laser device 45 as shown in FIG. 5. A wavelength filter 55 is disposed on a proceeding route of a part of the laser beam that is reflected by the half-mirror 50. A photodiode 54 is fixed on a mount 53 on the extension line of the wavelength filter 55. A photodiode 57 is fixed on a mount 56 on a proceeding route of a part of the laser beam that is reflected by the half-mirror 51.

The provision of the wavelength monitoring section 48 in front of the laser device 45 has the following advantages. By providing the wavelength monitoring section 48 in front of the laser device 45, it is not necessary to dispose a lens that makes the laser beam parallel beams at the back of the laser device 45. This has an advantage of decreasing the number of parts. Further, by providing the wavelength monitoring section 48 in front of the laser device 45, the laser device 45 is provided at the backside on the temperature control module 2 via the laser mount 44. On the other hand, it is necessary to dispose the isolator 49 at a position close to the optical fiber 22 that is connected to the laser module. Therefore, the isolator 49 is disposed on the temperature control module 3, unlike the laser device 45.

The wavelength monitoring section 48 monitors the wavelength by taking out a part of the laser beam that has been emitted to the forward direction. Specifically, the wavelength monitoring section 48 takes out a part of the laser beam with the half-mirror 50, and makes this laser beam incident to the photodiode 54 via the wavelength filter 55 that passes through only the beam of a specific wavelength. The laser beam that has been incident to the photodiode 54 is converted into a current, and is output. The intensity of the laser beam of the specific wavelength is detected as an electric signal. The laser beam that has been taken out by the other half-mirror 51 is used as a reference light, and is detected as an electric signal at the photodiode 57, thereby to monitor the wavelength.

The isolator 49 is used to interrupt a laser beam that is incident to the laser module from the outside. The wavelength to be interrupted and the efficiency of the interruption change depending on temperature. Therefore, in order to stabilize the operation of the laser module, it is more desirable to keep constant the temperature of the isolator 49. On the other hand, the temperature of the laser device 45 is intentionally changed sometime in order to stabilize the wavelength. Therefore, the temperature of the laser device 45 is controlled within a range of temperature different from the usual temperature. As a result, by disposing the isolator 49 on the temperature control module different from the temperature control module on which the laser device 45is disposed, it becomes possible to interrupt the light from the outside more efficiently.

In the laser module according to the second embodiment, the laser device 45 is disposed on the temperature control module 2 that is different from the temperature control module 3 on which the wavelength monitoring section 48 including the isolator 49 and the wavelength filter is disposed. Therefore, even when the temperature of the laser device 45 is largely changed, this does not affect the performance of the laser module as a whole. Consequently, the temperature control module 2 can stabilize the oscillation wavelength when laser beams of different wavelengths are oscillated, by not only stabilizing the laser beam emitted from the laser device 45 at a predetermined wavelength but also positively changing the temperature of the laser device 45.

As explained above, in the laser module according to the second embodiment, it is anticipated that the temperature of the ceramic plate disposed on the temperature control module 2 is different from the temperature of the ceramic plate disposed on the temperature control module 3. As the ceramic plate is a material of high thermal conductivity, there is a risk that heat is conducted from one temperature control module to the other temperature control module when the module 2 and the module 3 are brought into contact with each other. Therefore, the adiabatic plate 24 is disposed between the modules 2 and 3, to interrupt the shift of heat between the modules 2 and 3. The adiabatic plate 24 is disposed to eliminate the interference between the modules 2 and 3, and thereby it is possible to achieve mutually independent temperature control.

There is also an advantage that it is possible to minimize the power consumption of the laser module by disposing the adiabatic plate 24 between the modules 2 and 3. In other words, when heat is shifted between the modules 2 and 3, it becomes necessary to increase the quantity of current that is flown to the Peltier device in order to maintain the temperature control modules at predetermined temperatures. Based on the provision of the adiabatic plate 24, it becomes unnecessary to flow such large current. As a result, it is possible to minimize the power consumption.

When the modules 2 and 3 are in contact with each other while there is a large difference in temperatures between the modules 2 and 3, the Peltier device cannot carry out the temperature control, as heat continues to flow in or flow out. Consequently, the Peltier device cannot be used as a product. It is possible to prevent the occurrence of this situation, by providing the adiabatic plate 24 between the modules 2 and 3. As a result, the laser module according to the second embodiment allows improvement in the yields of its manufacture.

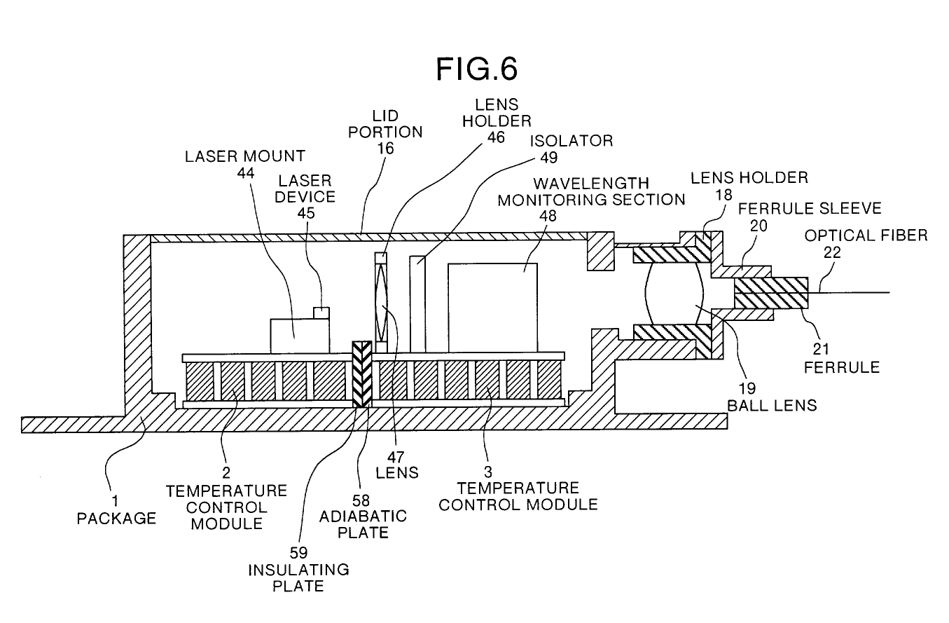

A third embodiment of the present invention will be explained next with reference to FIG. 6. FIG. 6 is a cross-sectional view which shows the structure of a laser module according to the third embodiment. In the third embodiment, sections that are identical or similar to those of the first and second embodiments are assigned with identical reference symbols, and explanation of these sections will be omitted.

The laser module according to the third embodiment has the package 1, and the temperature control module 2 and the temperature control module 3 that are disposed on the bottom surface inside the package 1. The laser device 45 is disposed on the module 2 via the laser mount 44. The isolator 49, the wavelength monitoring section 48, and the lens 47 held by the lens holder 46 are disposed on the module 3. The lid portion 16 is disposed on the upper opening section of the package 1 to seal the inside of the package 1, that is, to shield the package 1 from the outside. An insulating plate 59 and an adiabatic plate 58 are disposed between the modules 2 and 3 on the bottom surface inside the package 1.

As described above, the temperature control module 2 has an object of making constant the wavelength of the laser beam that is oscillated from the laser device 45. On the other hand, the temperature control module 3 has an object of making constant the temperature of the wavelength filter and the isolator 49 that are provided inside the wavelength monitoring section 48. Therefore, the temperature of the module 2 is generally different from the temperature of the module 3. The magnitude of a current that flows to the Peltier device that constitutes the module 2 is different from the magnitude of a current that flows to the Peltier device that constitutes the module 3.

When the temperature control module 2 is in contact with the temperature control module 3, electrical conduction occurs between the modules 2 and 3 based on the structure of the Peltier device. When the electrical conduction has occurred, it is impossible to control the module 2 and the module 3 independently. Therefore, the insulating plate 59 is disposed to secure insulation. However, even when the module 2 and the module 3 are electrically separated, power consumption of the respective Peltier devices each of which constitutes the temperature control module increases when heat shift occurs between the temperature control modules. Therefore, in addition to the insulating plate 59, the adiabatic plate 58 is disposed between the modules 2 and 3, and thereby it becomes possible to thermally separate the module 2 from the module 3 and to efficiently carry out the temperature control.

Instead of separately disposing the insulating plate 59 and the adiabatic plate 58 between the temperature control module 2 and the temperature control module 3, one plate having both the electric insulation function and the heat insulation function may be provided. As a material having such functions, there is porous alumina that has a low sintering level. Among the materials that have been explained as materials for the adiabatic plate, there are also materials that function as an insulator. When one plate has both the electric insulation function and the heat insulation function, the process of manufacturing the laser module according to the third embodiment can be simplified. Therefore, the plate has such an advantage that it is possible to effectively utilize the bottom surface inside the package 1.

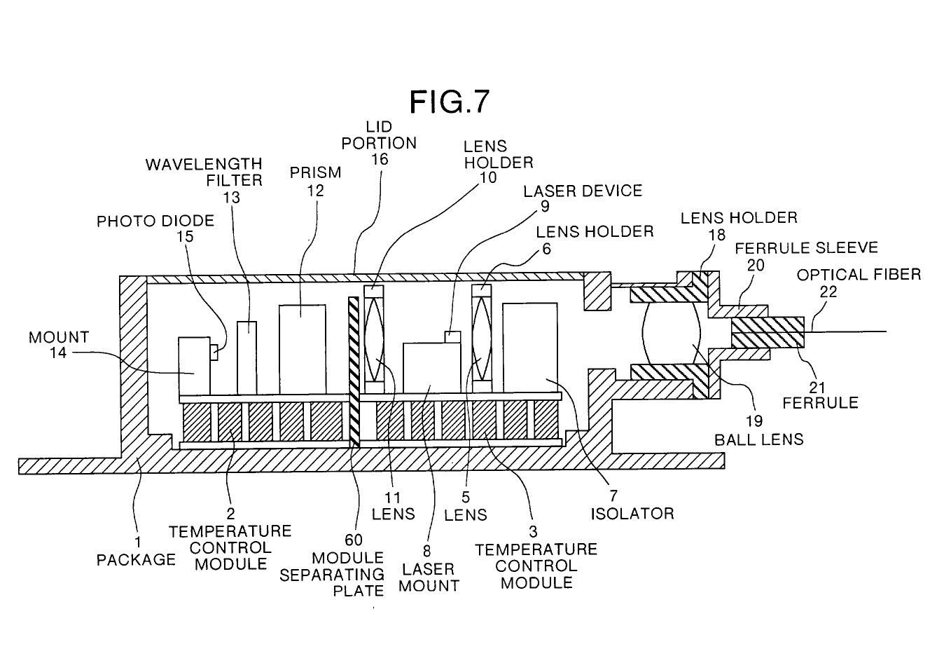

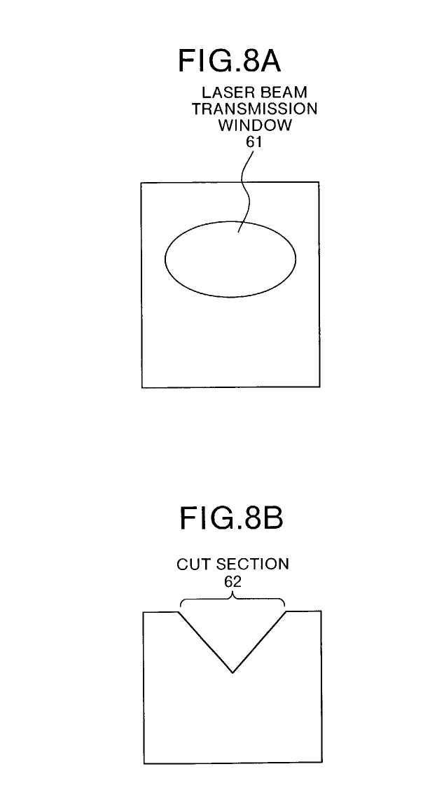

A laser module according to a fourth embodiment will be explained with reference to FIG. 7 and FIG. 8. FIG. 7 is a cross-sectional view which shows the structure of a laser module according to the fourth embodiment. FIGS. 8A and 8B show the structure of a module separating plate 60 as viewed from a direction of the optical axis of a laser beam in the laser module.

In the laser module according to the fourth embodiment, the package 1 has opening sections on the top and at the right side surface of the module. The temperature control module 3 and the temperature control module 2 are disposed on the internal bottom surface of the package 1 in this order from the side surface having the opening section to the leftward direction. On the module 3, the isolator 7, the lens 5 held by the lens holder 6, the laser device 9 disposed via the laser mount 8, and the lens 11 held by the lens holder 10 are disposed in this order from the side surface having the opening section to the leftward direction. On the module 2, the prism 12, the wavelength filter 13, and the mount that holds the photodiode 15 are disposed in this order from the side nearest to the module 3 to the leftward direction. The module separating plate 60 is disposed between the module 3 and the module 2. The top opening section of the package 1 is closed with the lid portion 16. The internal space of the package 1 is filled with inert gas to be shielded from the outside.

The module separating plate 60 is constructed of a flat plate disposed between the modules 2 and 3. The module separating plate 60 is higher than the modules 2 and 3, and may reach the height of the lid portion 16. The module separating plate 60 is made of a material having electric insulation or heat insulation properties, but may be made of a material such as glass fiber and foamed cement that have both the electric insulation and heat insulation properties. The module separating plate 60 has a window provided at the upper portion so as not to interrupt a laser beam that is emitted from the laser device 9 to the backward direction.

In the fourth embodiment, based on the provision of the module separating plate 60, it is possible to separate the temperature control module 2 from the temperature control module 3 in a similar manner to that of the first to third embodiments. Therefore, it is possible to prevent the shift of heat or a current conduction between the module 2 and the module 3 due to being in contact with each other. Further, by making the module separating plate 60 higher than the modules 2 and 3, it is possible to obtain the following effects.

The laser module according to the fourth embodiment is generally used as a signal light source for optical data communications. For example, the laser module is used as a signal light source of a WDM optical communication system. As the signal light source is constructed of a plurality of laser modules, a part of laser beams emitted from the own and other laser modules may be reflected from the light connector and incident to the laser module according to the fourth embodiment. Further, apart of the laser beam emitted from the front of the laser device 9 may generate a random reflection within the package. When these lights are incident to the photodiode 15, there is a risk that the function of the wavelength monitor to detect the wavelength of the laser beam emitted from the laser device 9 to the backward direction may be damaged. By disposing the module separating plate 60, it is possible to prevent these lights from being incident to the photodiode 15. These stray lights occur at the right side of the laser device 9 in FIG. 7. Therefore, by disposing the module separating plate 60, it is possible to prevent these stray lights from entering the space area at the left side of the module separating plate 60. Consequently, it is possible to highly precisely monitor wavelengths by increasing the height of the module separating plate 60.

The internal space of the package 1 is sealed with gas like inert gas. Therefore, when the temperature of the laser device 9 rises, there is a risk that convection occurs in the internal space of the package 1. Consequently, even when the temperature control module 2 is separated from the temperature control module 3 to prevent radiant heat, there is a risk that the temperature of the wavelength filter 13 may change. Based on the provision of the module separating plate 60, it is possible to prevent the high-temperature gas from being in contact with the wavelength filter 13 due to the convection to generate electric heating. From this viewpoint, it is preferable that the module separating plate 60 is completely in contact with the lid portion 16.

When the laser beam emitted from the laser device 9 to the backward direction is interrupted by the module separating plate 60, the photodiode 15 cannot monitor the wavelength. Therefore, the window is provided at the upper section of the module separating plate 60 to pass the laser beam that has been emitted to the backward direction. FIGS. 8A and 8B show shapes of the window. FIG. 8A shows an oval laser beam transmission window 61, and FIG. 8B shows a structure of the module separating plate 60 having a cut section 62 on the top. The laser beam passes through the laser beam transmission window 61 or the space formed by the cut section 62, and is incident to the wavelength filter 13 and the photodiode 15. The window may have a structure that sufficiently passes through the laser beam, and the shape of the module separating plate 60 is not limited to those shown in FIGS. 8A and 8B. For example, the laser beam transmission window 61 may be in a circular shape, and the cut section 62 may be in a square shape instead of a triangular shape. The module separating plate 60 may be in any shape that can interrupt the laser beam at a certain rate if the module separating plate 60 can effectively interrupt the light other than the laser beam emitted from the back of the laser device 9. This is because the wavelength is monitored by detecting a change in the intensity of the laser beam that is irradiated to the photodiode 15 and it is sufficiently possible to monitor the wavelength when the module separating plate 60 allows the laser beam to transmit at a certain rate.

In the fourth embodiment, although the laser beam transmission window 61 and the cut section 62 are void, it is also possible to structure this area with a sheet glass that can transmit the laser beam or the like. When the sheet glass is used, the space in which the temperature control module 2 is disposed is separated from the space in which the temperature control module 3 is disposed, and it becomes possible to more efficiently prevent thermal conduction due to the convection.

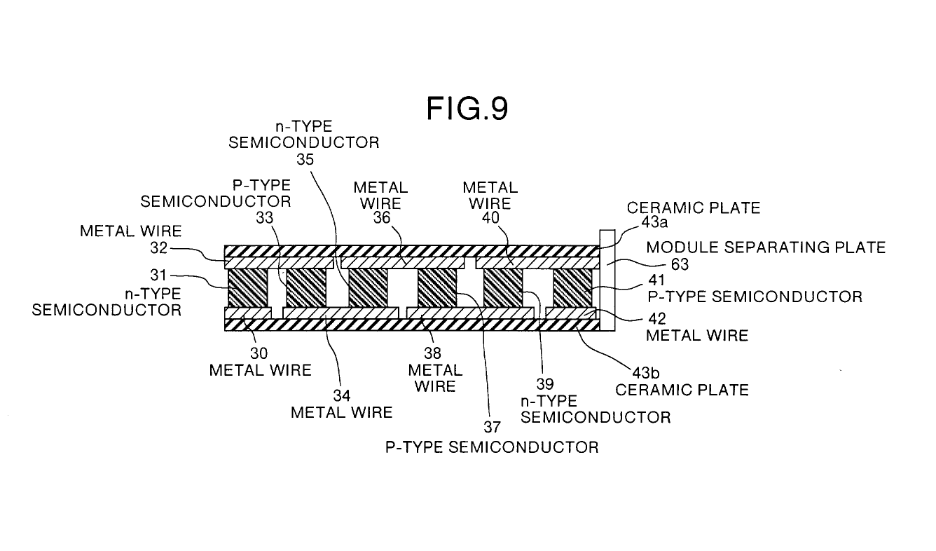

A fifth embodiment of the present invention will be explained with reference to FIG. 9. FIG. 9 is a cross-sectional view which shows the structure of a temperature control module according to the fifth embodiment. Sections similar to those of the temperature control module in the first embodiment shown in FIG. 3 are assigned with identical reference symbols, and explanation of their sections will be omitted.

The temperature control module according to the fifth embodiment is constructed of the Peltier device. A module separating plate 63 is fixed to the side surface of the temperature control module. The module separating plate 63 is made of a material having an electric insulation or heat insulation property. A material having both properties may also be used.

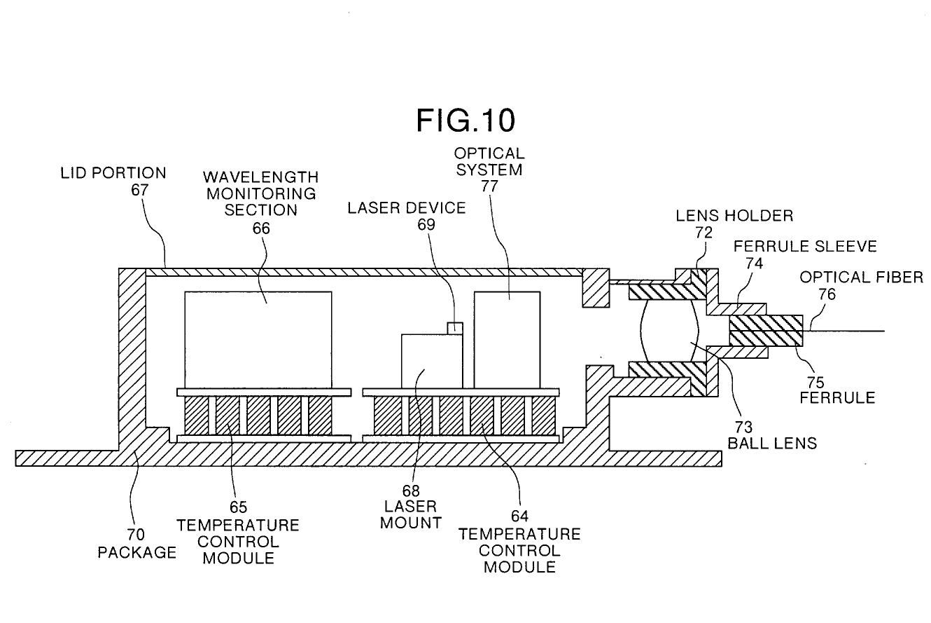

The module separating plate 63 is used to separate temperature control modules that are disposed within the laser module from each other. When the temperature control module according to the fifth embodiment is used in place of the temperature control module 65 shown in FIG. 10, it is possible to completely separate the temperature control module 64 from the temperature control module according to the fifth embodiment by the module separating plate 63.

There are the following advantages when the module separating plate 63 is fixed to the temperature control module, instead of disposing in advance the module separating plate in the package that constitutes the laser module. When the module separating plate is disposed in the package, it is necessary to have a process of fixing the module separating plate on the bottom surface inside the package. On the other hand, when the temperature control module according to the fifth embodiment is used, the process of disposing the module separating plate is not necessary, and it is possible to manufacture the laser module according to the conventional method. Further, it is possible to surely separate the temperature control modules from each other. Therefore, when the laser module is manufactured using the temperature control module of the fifth embodiment, it is possible to increase the yields based on the conventional manufacturing method.

In the temperature control module according to the fifth embodiment, the module separating plate 63 may be disposed on the surface at the left side. Module separating plates may be fixed to a plurality of side surfaces instead of fixing a module separating plate to only one side surface. The module separating plate 63 may have a shape having a smaller height than the side surface of the Peltier device, instead of having a sufficiently large height to cover the side surface of the Peltier device. For example, even when the ceramic plate 43a that constitutes the Peltier device is not covered with the module separating plate 63, the existence of the module separating plate 63 makes it possible to keep a space from other temperature control modules. Such a structure can be realized by extending the ceramic plate 43b to a horizontal direction in advance. Conversely, the module separating plate 63 may be higher than the Peltier device. In this case, it is possible to achieve the function of the module separating plate 60 according to the fourth embodiment. The temperature control modules may be fixed to a common substrate in advance so as to be isolated from each other.

Although the first to fifth embodiments have been explained above, it should be understood that the description and the drawings that form a part of the disclosure of the present invention do not limit the present invention. From the above disclosure, it is considered that those who are skilled in the art are able to implement various modifications and operational techniques. For example, in the first embodiment, it is possible to separate the temperature control module 2 from the temperature control module 3 using a material having the heat insulation property instead of using the insulating plate 4 by placing emphasis on the heat insulation effect. Further, it is also possible to dispose a flat plate made of a material having both the heat insulation and electric insulation properties instead of using the insulating plate 4.

The laser modules according to the first to fourth embodiments are not limited to the laser module having the temperature control modules 2 and 3 each constructed of the Peltier device respectively. When any device electrically adjusts temperature and has a risk of current conductance when temperature control modules are in contact with each other, the insulating plate 4 is disposed between the temperature control modules 2 and 3 and it is there by possible to carry out correct temperature control. In the case of using any device having a structure of the occurrence of thermal conduction when the temperature control modules are in contact with each other, the adiabatic plate 24 can be used. Similarly, the temperature control module according to the fifth embodiment can also be constructed of any device other than the Peltier device.

In the first to fourth embodiments, the beam emitted from the laser device 9 to the backward direction is split into beams of two directions with the prism 12, it is also possible to use a half-mirror instead of the prism 12. This is because the half-mirror also has the function of splitting a laser beam.

Even though any laser module has an entire structure different from that of the explained laser module, the present invention can be applied to a case where the laser module has a plurality of temperature control modules each of which carries out different temperature control. For example, it is possible to apply the present invention to a laser module that does not have a wavelength monitoring section but has the laser device 9 and the isolator 7, and that controls their temperatures separately. Likewise, the laser module may be used for an excitation source of optical communications, not only for the signal light source of optical communications. It is also possible to use the laser module for a light source of an optical pickup apparatus, or a light source of an exposure apparatus in the manufacture of semiconductor apparatuses.

The insulating plates 4 and 59, the adiabatic plates 24 and 58, and the module separating plate 60 are components that are independent of the package. These components may be fixed to the package at the time of manufacturing the laser module. If possible, these plates may be integrally formed with the package. In this case, it is possible to omit the process of fixing these plates to the package, and therefore, it is possible to facilitate the manufacturing of the laser module.

In the first to fourth embodiments, the temperature control modules 2 and 3 are disposed inside the laser module, but the number of the temperature control modules is not limited. If possible, three or more temperature control modules may be disposed inside the laser module. The isolator 7 shown in FIG. 1 also has temperature dependency like the wavelength filter 13. Therefore, in order to more exhibit the performance of the isolator 7, it is preferable that another temperature control module is provided inside the laser module separately from the temperature control module 3 and the isolator 7 is disposed on this temperature control module. It is needless to mention that the insulating plate is disposed between the newly provided temperature control module and the temperature control module 3.

As explained above, according to one aspect of the present invention, when the first temperature control module and the second temperature control module are provided inside the package, the module separating unit is disposed between these temperature control modules. Therefore, it is possible to prevent the temperature control modules from being in contact with each other.

Moreover, the module separating unit has an insulation property. Therefore, there is no current conduction between the temperature control modules, and each temperature control module can carry out a temperature control independently.

Furthermore, the module separating unit has a heat insulation property. Therefore, it is possible to prevent the shift of heat between the temperature control modules, and to minimize power consumption for the temperature adjustment.

Moreover, the module separating unit has electric insulation and heat insulation properties. Therefore, there is no current conduction between the temperature control modules, and it is therefore possible to prevent the shift of heat between the temperature control modules.

Furthermore, the module separating unit is integrally formed with the package. Therefore, it is possible to manufacture the laser module in the same process as the conventional process and to prevent the temperature control modules from being in contact with each other.

Moreover, the module separating unit has the laser beam transmission window. Therefore, it is possible to prevent the temperature control modules from being in contact with each other, without interrupting the laser beam that is emitted from the laser device. Further, it is possible to minimize the shift of heat due to the convection between the temperature control modules.

Furthermore, the module separating plate is fixed to the side surface of the temperature control module in advance. Therefore, it is possible to provide the laser module that can avoid the temperature control modules from being in contact with each other even when the package of the conventional shape is used.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A laser module comprising:
a first temperature control module that is disposed inside a package;
a second temperature control module that is also disposed inside the package;
a laser device that is disposed on the first temperature control module and emits light;
a wavelength monitoring section that is disposed on the second temperature control module, and detects a wavelength of the light emitted from the laser device; and
a module separating unit that is disposed between the first and second temperature control modules, and that includes at least a device separator to separate the temperature control modules from each other.

2. The laser module according to claim 1, wherein the module separating unit includes at least an electrical insulator.

3. The laser module according to claim 1, wherein the module separating unit includes at least a heat insulator.

4. The laser module according to claim 1, wherein the module separating unit includes at least a material having electric insulating and heat insulating properties.

5. The laser module according to claim 1, wherein the module separating unit is integrally formed with the package.

6. The laser module according to claim 1, wherein the module separating unit has a laser beam transmission window.

7. The laser module according to claim 1, wherein the temperature control modules carry out temperature control based on application of a current from an external control unit, and at least one of the temperature control modules has the module separating unit that is fixed to a side surface thereof facing to the adjacent temperature control module so as to separate the temperature control module from the adjacent temperature control module.

8. The laser module according to claim 1, wherein the temperature control modules carry out temperature control based on application of a current from an external control unit, and at least one of the temperature control modules is extended at one edge of its bottom toward the adjacent temperature control module so as to form a space between the temperature control module and the adjacent temperature control module.

9. The laser module according to claim 1, wherein the first temperature control module and the second temperature control module are fixed on a common substrate at positions where the temperature control modules are not in contact with each other, and the common substrate is installed inside the package.
